(19) United States
(12) Patent Application Publication
(10) Pub. No.: US 2014/0267449 A1
(43) Pub. Date: Sep. 18, 2014

(54) DISPLAY PANEL, METHOD OF DRIVING THE SAME AND DISPLAY APPARATUS HAVING THE SAME

(71) Applicant: Samsung Display Co., Ltd., Yongin-city (KR)

(72) Inventors: Sung-Jin HONG, Hwaseong-si (KR); Jae-Hyun Cho, Seoul (KR); Jae-Woong Kang, Jeonju-si (KR); Jae-Byung Park, Seoul (KR); Kwang-Chul Jung, Seongnam-si (KR); Hyun-Min Cho, Hwaseong-si (KR)

(73) Assignee: Samsung Display Co., Ltd., Yongin-city (KR)

(21) Appl. No.: 14/150,370

(22) Filed: Jan. 8, 2014

(30) Foreign Application Priority Data
Mar. 14, 2013 (KR) 10-2013-0027177

(51) Int. Cl. G09G 3/36

(52) U.S. Cl. CPC G09G 3/3655
USPC 345/690; 345/89

(57) ABSTRACT

A display panel includes a plurality of gate lines, a plurality of date lines and a plurality of pixel portions. The gate lines transfer gate signals. The data lines transfer intersect with the gate lines and transfer data signals. The pixel portions and the data lines, include pixel electrodes, and charge a pixel voltage by using a first gamma signal and a second gamma signal. The first gamma signal is changed from a first level lower than a common voltage to a second level higher than the common voltage as a grayscale is increased. The second gamma signal is changed from a third level higher than the common voltage to a fourth level lower than the common voltage as the grayscale is increased. A display quality of the display apparatus may thus be improved.

### CROSS REFERENCE TO RELATED APPLICATION

This application claims priority from and the benefit of Korean Patent Application No. 10-2013-0027177, filed on Mar. 14, 2013, which is hereby incorporated by reference for all purposes as if fully set forth herein.

### BACKGROUND OF THE INVENTION

1. Field of the Invention

Exemplary embodiments of the present invention relate to a display panel, a method of driving the display panel and a display apparatus including the display panel. Exemplary embodiments of the present invention relate to a display panel including simultaneously driven pixels, a method of driving the display panel and a display apparatus is having the display panel.

2. Discussion of the Background

A liquid crystal display apparatus typically includes a color filter layer including various colored filters, and the image on the liquid crystal display is controlled by controlling a quantity of light being transmitted through the color filter layer. Luminance may be decreased by the color filter layer. In order to address the decrease in luminance in a liquid crystal display panel, a field sequential driving method has been developed.

In the field sequential driving method, a light source providing the light to a display panel of the liquid crystal display apparatus may include various colored light emitting parts, for example, a red light emitting part emitting a red light, a green light emitting part emitting a green light, and a blue light emitting part emitting a blue light, etc. that are sequentially turned on. In the field sequential driving method, pixel voltages are simultaneously charged in liquid crystal capacitors of pixels to prevent a color mixture. Image quality may deteriorate due to pixel voltages charged in the liquid crystal capacitors in a previous frame period.

### SUMMARY OF THE INVENTION

Exemplary embodiments of the present invention provide a display panel capable of improving display quality.

Exemplary embodiments of the present invention also provide a method of driving the above-mentioned display panel.

Additional features of the invention will be set forth in the description which follows, and in part will be apparent from the description, or may be learned by practice of the invention.

Exemplary embodiments of the present invention provide a display panel including a plurality of gate lines, a plurality of data lines intersecting the gate lines, and a plurality of pixel portions. The pixel portions comprise pixel electrodes are configured to charge a pixel voltage by using a first gamma signal and a second gamma signal, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased.

Exemplary embodiments of the present invention also provide a method of driving a display panel, the method including charging a data voltage in a memory capacitor by using a first gamma signal and a second gamma signal. The data voltage corresponding to a data signal applied from a data line, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased. The method provide boosting of the data voltage stored in the memory capacitor, resetting a previous pixel voltage charged in a liquid crystal capacitor and transferring the data voltage charged in the memory capacitor to the liquid crystal capacitor to charge a pixel voltage in the liquid crystal capacitor.

Exemplary embodiments of the present invention also provide a display apparatus including a display panel comprising a plurality of gate lines, a plurality of data lines intersecting with the gate lines, and a plurality of pixel portions. The plurality of pixel portions comprise a pixel electrode and are configured to charge a pixel voltage by using a first gamma signal and a second gamma signal, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased. The display apparatus further includes a gate driving part configured to output the gate signals and a data driving part configured to output the data signals.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a display apparatus according to exemplary embodiments of the present invention.

FIG. 2 is a circuit diagram illustrating a pixel portion of FIG. 1 according to exemplary embodiments of the present invention.

FIG. 3 is a circuit diagram illustrating a gamma signal generating part in a data driving part of FIG. 1 according to exemplary embodiments of the present invention.

FIG. 4 is a graph illustrating a first gamma signal and a second gamma signal generated from a gamma signal generating part of FIG. 3 according to exemplary embodiments of the present invention.

FIG. 5 is waveforms illustrating signals applied to a display panel of FIG. 1 according to exemplary embodiments of the present invention.

FIG. 6 is a flow chart illustrating a method of driving a display panel driving the display panel of FIG. 1 according to exemplary embodiments of the present invention.

FIG. 7 is a timing diagram illustrating a frame period of the image data DATA applied to the data driving part of FIG. 1 according to exemplary embodiments of the present invention.

FIG. 8A and FIG. 8B are cross sectional views illustrating a display panel and a light source part according to exemplary embodiments of the present invention.

FIG. 9 is a timing diagram illustrating a time period of an image data applied to a display panel of FIG. 8 according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention are described in detail with reference to the accompanying drawings.

FIG. 1 is a block diagram illustrating a display apparatus according to exemplary embodiments of the present invention.

Referring to FIG. 1, the display apparatus 100 may include a display panel 110, a data driving part 120, a gate driving part 130, a timing control part 140, a light source part 150, a control signal generating part 160 and a voltage supplying part 170.

The display panel 110 may receive an image data DATA to display an image. The display panel 110 may include a plurality of gate lines GL parallel to a first direction D1, a plurality of data lines DL parallel to a second direction D2 where the second direction D2 is perpendicular to the first direction D1, and a plurality of pixel portions 200. The gate lines GL may transfer gate signals, the data lines DL may transfer data signals, and the pixel portions 200 may be defined by the gate lines GL and the data lines DL. The first direction D1 may be parallel with a long side of the display panel 110, and the second direction D2 may be parallel with a short side of the display panel 110.

FIG. 2 is a circuit diagram illustrating the pixel portions 200 of FIG. 1.

Referring to FIG. 1 and FIG. 2, the pixel portions 200 may include a storing part 201 and a liquid crystal driving part 202.

The storing part 201 may include a first thin film transistor 210 and a memory capacitor 240.

The first thin film transistor 210 may include a gate electrode electrically connected to the gate line GL, a source electrode electrically connected to the data line DL, and a drain electrode electrically connected to the memory capacitor 240.

The memory capacitor 240 may charge a data voltage corresponding to the data signal applied from the data line DL through the first thin film transistor 210. The pixel portions 200 may sequentially charge the data voltage to the memory capacitors 240 in response to gate signals being sequentially applied from the gate lines GL. The memory capacitor 240 may include a first terminal electrically connected to the drain electrode of the first thin film transistor 210 and a second terminal electrically connected to a boosting voltage line VBSTL transferring a boosting voltage VBST boosting the data voltage charged in the memory capacitor 240.

The liquid crystal driving part 202 may include a second thin film transistor 220, a third thin film transistor 230, a liquid crystal capacitor 250 and a storage capacitor 260.

The second thin film transistor 220 may include a source electrode electrically connected to the drain electrode of the first thin film transistor 210 and the first terminal of the memory capacitor 240, a gate electrode electrically connected to an update line UL transferring an update signal US for charging a pixel voltage to the liquid crystal capacitor 250 by transferring the data voltage charged in the memory capacitor 240 to the liquid crystal capacitor 250, and a drain electrode electrically connected to the liquid crystal capacitor 250, the storage capacitor 260, and the third thin film transistor 230.

The liquid crystal capacitor 250 may receive the data voltage charged in the memory capacitor 240 and boosted through the second thin film transistor 220 to charge the pixel voltage when the update signal transferred through the update line UL is activated. The pixel portions 200 may simultaneously charge the pixel voltage to the liquid crystal capacitor 250. The liquid crystal capacitor 250 may include a first terminal electrically connected to the drain electrode of the second thin film transistor 220 and a second terminal electrically connected to a common voltage line VCOML transferring a common voltage.

The storage capacitor 260 may be connected to the liquid crystal capacitor 250 in parallel, and may maintain the pixel voltage charged in the liquid crystal capacitor 250. The storage capacitor 260 may include a first terminal electrically connected to the drain electrode of the second thin film transistor 220 and a second terminal electrically connected to the common voltage line VCOML.

The third thin film transistor 230 may include a source electrode electrically connected to the common voltage line VCOML, a gate electrode electrically connected to a reset line RL transferring a reset signal RS resetting a previous pixel voltage charged in the liquid crystal capacitor 250, and a drain electrode electrically connected to the first terminal of the liquid crystal capacitor 250. The previous pixel voltage may be reset and the common voltage VCOM may be charged in the liquid crystal capacitor 250 when the reset signal RS applied to the gate electrode of the third thin film transistor 230 is activated. The display panel 110 may display a black image when the reset signal RS is activated.

The data driving part 120 may output data signals based on the image data DATA to the data lines DL in response to a first clock signal CLK1 and a horizontal start signal STH provided from the timing control part 140. The data driving part 120 may output a first gamma signal and a second gamma signal. The first gamma signal may change from a first level, lower than a common voltage VCOM, to a second level higher than the common voltage VCOM as a grayscale is increased. The second gamma signal may change from a third level, higher than the common voltage VCOM, to a fourth level lower than the common voltage as the grayscale is increased. The data signal may include the first gamma signal and the second gamma signal.

The gate driving part 130 may generate gate signals using a vertical start signal STV and a second clock signal CLK2 provided from the timing control part 140, and may output the gate signals to the gate lines GL.

The timing control part 140 may receive the image data DATA and a control signal CON from outside. The control signal CON may include, for example, a horizontal synchronous signal Hsync, a vertical synchronous signal Vsync and a clock signal CLK.

The timing control part 140 may generate the horizontal start signal STH using the horizontal synchronous signal Hsync and may output the horizontal start signal STH to the data driving part 120. The timing control part 140 may generate the vertical start signal STV using the vertical synchronous signal Vsync and may output the vertical start signal STV to the gate driving part 130. The timing control part 140 may generate the first clock signal CLK1 and the second clock signal CLK2 using the clock signal CLK, and may output the first clock signal CLK1 to the data driving part 120 and output the second clock signal CLK2 to the gate driving part 130. The timing control part 140 may output a light source control signal LCS controlling the light source part 150 to the light source part 150.

The light source part 150 may generate light LIGHT and may output the light LIGHT to the display panel 110. The light source part 150 may be a plurality of light emitting parts sequentially generating lights having colors different from each other in response to the light source control signal LCS. For example, the light source part 150 may include a red light emitting part emitting a red light, a green light emitting part emitting a green light, and a blue light emitting part emitting a blue light.

The control signal generating part 160 may output the reset signal RS to the reset line RL in the display panel 110 and output the update signal US to the update line UL in the display panel 110. The reset signal RS may be applied to the third thin film transistor 230 in the display panel 110 to reset the previous pixel voltage charged in the liquid crystal capacitor 250. The update signal US may be applied to the second thin film transistor 220 in the display panel 110 to transfer the data voltage charged in the first capacitor 240 and boosted to the liquid crystal capacitor 250.

The voltage supplying part 170 may output the common voltage VCOM to the common voltage line VCOML in the display panel 110 and may output the boosting voltage VBST to the boosting voltage line VBSTL in the display panel 110.

FIG. 3 is a circuit diagram illustrating a gamma signal generating part in the data driving part 120 of FIG. 1.

Referring to FIG. 3, the gamma signal generating part 180 may include an external gamma correction voltage generating circuit 190, a first gamma signal generating part 191 and a second gamma signal generating part 192.

The external gamma correction voltage generating circuit 190 may generate external voltages VGMA1 to VGMA18 to output the external voltages VGMA1 to VGMA18. For example, the external gamma correction voltage generating circuit 190 may output first to ninth output external voltages VGMA1 to VGMA9 to the first gamma signal generating part 191 and output tenth to eighteenth external voltages VGMA10 to VGMA18 to the second gamma signal generating part 192.

The first gamma signal generating part 191 may include a plurality of resistors R0 to R254. Resistors R0 to R56 may be connected between a line transferring the ninth external voltage VGMA9 and a line transferring the eighth external voltage VGMA8. Resistance of the resistors R0 to R56 may be about 2903 ohms. Resistors R56 to R71 may be connected between the line transferring the eighth external voltage VGMA8 and a line transferring the seventh external voltage VGMA7. Resistance of the resistors R56 to R71 may be about 836 ohms. Resistors R72 to R99 may be connected between the line transferring the seventh external voltage VGMA7 and a line transferring the sixth external voltage VGMA6. Resistance of the resistors R72 to R99 may be about 1846 ohms. Resistors R100 to R139 may be connected between the line transferring the sixth external voltage VGMA6 and a line transferring the fifth external voltage VGMA5. Resistance of the resistors R100 to R139 may be about 2352 ohms. Resistors R140 to R175 may be connected between the line transferring the fifth external voltage VGMA5 and a line transferring the fourth external voltage VGMA4. Resistance of the resistors R140 to R175 may be about 1960 ohms. Resistors R176 to R199 may be connected between the line transferring the fourth external voltage VGMA4 and a line transferring the third external voltage VGMA3. Resistance of the resistors R176 to R199 may be about 2054 ohms. Resistors R200 to R247 may be connected between the line transferring the third external voltage VGMA3 and a line transferring the second external voltage VGMA2. Resistance of the resistors R200 to R247 may be about 3118 ohms. Resistors R248 to R253 may be connected between the line transferring the second external voltage VGMA2 and a line transferring the first external voltage VGMA1. Resistance of the resistors R248 to R253 may be about 3153 ohms. Resistor R254 may be connected between the line transferring the first external voltage VGMA1 and a line transferring a first gamma voltage GAMMA_VDD2. Resistance of the resistor R254 may be about 4000 ohms.

The second gamma signal generating part 192 may include a plurality of resistors R0 to R254. Resistors R0 to R56 may be connected between a line transferring the tenth external voltage VGMA10 and a line transferring the eleventh external voltage VGMA11. Resistance of the resistors R0 to R56 may be about 2903 ohms. Resistors R56 to R71 may be connected between the line transferring the eleventh external voltage VGMA11 and a line transferring the twelfth external voltage VGMA12. Resistance of the resistors R56 to R71 may be about 836 ohms. Resistors R72 to R99 may be connected between the line transferring the twelfth external voltage VGMA12 and a line transferring the thirteenth external voltage VGMA13. Resistance of the resistors R72 to R99 may be about 1846 ohms. Resistors R100 to R139 may be connected between the line transferring the thirteenth external voltage VGMA13 and a line transferring the fourteenth external voltage VGMA14. Resistance of the resistors R100 to R139 may be about 2352 ohms. Resistors R140 to R175 may be connected between the line transferring the fourteenth external voltage VGMA14 and a line transferring the fifteenth external voltage VGMA15. Resistance of the resistors R140 to R175 may be about 1960 ohms. Resistors R176 to R199 may be connected between the line transferring the fifteenth external voltage VGMA15 and a line transferring the sixteenth external voltage VGMA16. Resistance of the resistors R176 to R199 may be about 2054 ohms. Resistors R200 to R247 may be connected between the line transferring the sixteenth external voltage VGMA16 and a line transferring the seventeenth external voltage VGMA17. Resistance of the resistors R200 to R247 may be about 3118 ohms. Resistors R248 to R253 may be connected between the line transferring the seventeenth external voltage VGMA17 and a line transferring the eighteenth external voltage VGMA18. Resistance of the resistors R248 to R253 may be about 3153 ohms. Resistor R254 may be connected between the line transferring the eighteenth external voltage VGMA18 and a line transferring a second gamma voltage GAMMA_VSS2. Resistance of the resistor R254 may be about 4000 ohms.

FIG. 4 is a graph illustrating a first gamma signal and a second gamma signal generated from the gamma signal generating part 180 of FIG. 3.

Referring to FIG. 1, FIG. 2, FIG. 3, and FIG. 4, the gamma signal generating part 180 may include the first gamma signal generating part 191 generating a first gamma signal HIGH GAMMA and the second gamma signal generating part 192 generating a second gamma signal LOW GAMMA. The first gamma signal HIGH GAMMA may change from a first level, lower than a common voltage VCOM, to a second level higher than the common voltage VCOM as a grayscale is increased, and the second gamma signal LOW GAMMA may change from a third level, higher than the common voltage VCOM, to a fourth level lower than the common voltage VCOM as the grayscale is increased. The first gamma signal HIGH GAMMA may be a high gamma signal, and the second gamma signal LOW GAMMA may be a low gamma signal.

The memory capacitor 240 in the display panel 110 may charge the data voltage including the first gamma signal HIGH GAMMA and a second gamma signal LOW GAMMA.

The pixel voltage charged in the liquid crystal capacitor 250 using the data voltage may be calculated by the following Equation 1.

VP=[VD*CMEM+(CLC+CST)*VRS]/(CMEM+CLC+CST) [Equation 1]

(VP: pixel voltage, VD: data voltage, CMEM: capacitance of the memory capacitor, CLC: capacitance of the liquid crystal capacitor, CST: capacitance of the storage capacitor, VRS: voltage of the reset signal)

For example, in case the capacitance of the memory capacitor 240 and (the capacitance of the liquid crystal capacitor 250+the capacitance of the storage capacitor 260) are the same, the common voltage may be about 8 volt (V), the boosting voltage VBST may be about 0 V to about 8 V, a voltage of the first gamma signal HIGH GAMMA may be about 2 V to about 16 V and a voltage of the second gamma signal LOW GAMMA may be about 0 V to 14 V, the data voltage charged in the memory capacitor 240, the data voltage charged in the memory capacitor 240 and boosted, the voltage charged in the liquid crystal capacitor 250 by reset from the reset signal RS, the pixel voltage charged in the liquid crystal capacitor 250 by the update signal US, and voltage applied to both terminals of the liquid crystal capacitor 250 may be the same as the following [Chart 1].

CHART 1

| | VCMEM | VCMEMBST | VCLCRS | VCLCUS | VCLCBT |
|---|---|---|---|---|---|
| High | 2 V | 10 V | 8 V | (10 + 8)/ | 1 V |
| gamma | | | | 2 = 9 V | |
| | 16 V | 24 V | 8 V | (24 + 8)/ | 8 V |
| | | | | 2 = 16 V | |
| Low | 14 V | 6 V | 8 V | (6 + 8)/ | −1 V |
| gamma | | | | 2 = 7 V | |
| | 0 V | −8 V | 8 V | (−8 + 8)/ | −8 V |
| | | | | 2 = 0 V | |

VCMEM denotes the data voltage charged in the memory capacitor 240, VCMEMBST denotes the data voltage charged in the memory capacitor 240 and boosted, VCLCRS denotes the voltage charged in the liquid crystal capacitor 250 by reset from the reset signal RS, VCLCUS denotes the pixel voltage charged in the liquid crystal capacitor 250 by the update signal US, and VCLCBT denotes the voltage applied to the both terminals of the liquid crystal capacitor 250.

Referring to the [Chart 1], when the first gamma signal HIGH GAMMA is outputted from the data driving part 120, the voltage applied to the both terminals of the liquid crystal capacitor 250 may be about 1 V to about 8V, and the display panel 110 may display a black grayscale to a white grayscale. When the second gamma signal LOW GAMMA is outputted from the data driving part 120, the voltage applied to the both terminals of the liquid crystal capacitor 250 may be about −1 V to about −8 V, and the display panel 110 may display the black grayscale to the white grayscale.

FIG. 5 is waveforms illustrating signals applied to the display panel 110 of FIG. 1.

Referring to FIG. 1, FIG. 2, FIG. 3, FIG. 4, and FIG. 5 and the [Chart 1], the data voltages VD corresponding to the data signals DS may be charged in the memory capacitors 240 respectively included in the pixel portions 200 in response to the gate signals GS sequentially being applied to the gate lines GL. In case the first gamma signal HIGH GAMMA is outputted from the data driving part 120, the data voltage VD charged in the memory capacitor 240 may be about 16 V. Alternatively, in case the second gamma signal LOW GAMMA is outputted from the data driving part 120, the data voltage VD charged in the memory capacitor 240 may be about 0 V. The data voltages VD charged in the memory capacitors 240 may be boosted in response to the boosting voltage VBST applied to the boosting voltage line VBSTL from the voltage supplying part 170. In case the first gamma signal HIGH GAMMA is outputted from the data driving part 120, the data voltage VD charged in the memory capacitor 240 and boosted may be about 24 V. Alternatively, in case the second gamma signal LOW GAMMA is outputted from the data driving part 120, the data voltage charged in the memory capacitor 240 and boosted may be about −8 V.

In addition, the previous pixel voltages previously charged in the liquid crystal capacitor 250 may be reset in response to the reset signal RS applied from the control signal generating part 160 to the reset signal line RL. In this case, the common voltage VCOM may be charged in the liquid crystal capacitor 250 and a black image may be displayed on the display panel 110. The common voltage VCOM may be about 8 V. The boosting voltage VBST and the reset signal RS may be simultaneously activated.

The data voltages VD charged in the memory capacitors 240 may simultaneously be transferred to the liquid crystal capacitors 250 in response to the update signal US applied from the control signal generating part 160 to the update signal line UL to simultaneously charge the pixel voltages VP to the liquid crystal capacitors 250. The pixel portions 200 may be simultaneously driven. In case the first gamma signal HIGH GAMMA is outputted from the data driving part 120, the pixel voltage VP charged in the liquid crystal capacitor 250 may be about 16 V, and the voltage applied to the both terminals of the liquid crystal capacitor 250 may be about 8 V. Alternatively, in case the second gamma signal LOW GAMMA is outputted from the data driving part 120, the pixel voltage VP charged in the liquid crystal capacitor 250 may be about 0 V, and the voltage applied to the both terminals of the liquid crystal capacitor 250 may be about −8 V.

FIG. 6 is a flow chart illustrating a method of driving a display panel driving the display panel 110 of FIG. 1.

Referring to FIG. 1, FIG. 2, FIG. 3, FIG. 4, FIG. 5, and FIG. 6, the data voltage VD may be charged in the memory capacitor 240 (step S110). The data voltages VD corresponding to the data signals DS may be charged in the memory capacitors 240 respectively included in the pixel portions 200 in response to the gate signal GS applied to the gate lines GL.

The data voltage VD charged in the memory capacitor 240 may be boosted (step S120). The boosting voltage VBST may be applied from the voltage supplying part 170 to the boosting voltage line VBSTL to boost the data voltage VD charged in the memory capacitor 240.

The previous pixel voltage charged in the liquid crystal capacitor 250 may be reset to charge the common voltage VCOM to the liquid crystal capacitor 250 (step S130). Reset signal RS may be applied from the control signal generating part 160 to the reset signal line RL to reset the previous pixel voltages previously charged in the liquid crystal capacitors 250. In this case, the common voltage VCOM may be charged in the liquid crystal capacitors 250.

The data voltage VD charged in the memory capacitor 240 may be transferred to the liquid crystal capacitor 250 to charge the pixel voltage VP to the liquid crystal capacitor 250 (step S140). The update signal US may be applied from the control signal generating part 160 to the update signal line UL to simultaneously transfer the data voltages VD charged in the memory capacitors 240 to the liquid crystal capacitors 250 and the pixel voltage VP may be simultaneously charged in the liquid crystal capacitors 250.

FIG. 7 is a timing diagram illustrating a frame period of the image data DATA applied to the data driving part 120 of FIG. 1.

Referring to FIG. 1, FIG. 2, FIG. 3, FIG. 4, FIG. 5, FIG. 6, and FIG. 7, the frame period FRAME may include a first sub frame period SF1, a second sub frame period SF2, and a third sub frame period SF3. Each of the first sub frame period SF1, the second sub frame period SF2, and the third sub frame period SF3 may include a first time T1, a second time T2, a third time T3, and a fourth time T4.

During the first time T1, the data voltages VD corresponding to the data signals DS may be sequentially charged in the memory capacitors 240 respectively included in the pixel portions 200 in response to the gate signals GS being sequentially applied to the gate lines GL.

During the second time T2, the data voltages VD charged in the memory capacitors 240 may be boosted in response to the boosting voltage VBST being applied to the boosting voltage line VBSTL from the voltage supplying part 170. In addition, during the second time T2, the previous pixel voltages previously charged in the liquid crystal capacitors 250 may be reset in response to the reset signal RS being applied to the reset signal line RL from the control signal generating part 160.

During the third time T3, the data voltages VD charged in the memory capacitors 240 may simultaneously be transferred to the liquid crystal capacitors 250 to charge the pixel voltages VP to the liquid crystal capacitors 250 in response to the update signal US being applied to the update signal line UL from the control signal generating part 160.

During the fourth time T4, the light source part 150 may emit light to apply the light LIGHT to the display panel 110. In case the light source part 150 includes the red light emitting part, the green light emitting part, and the blue light emitting part, the red light from the red light emitting part may be applied to the display panel 110 during the fourth time T4 of the first sub frame period SF1, the green light from the green light emitting part may be applied to the display panel 110 during the fourth time T4 of the second sub frame period SF2, and the blue light from the blue light emitting part may be applied to the display panel 110 during the fourth time T4 of the third sub frame period SF3. A display apparatus of field sequential driving (FSD) may be implemented, and a color filter may be unnecessary for the display panel 110.

According to the exemplary embodiments of the present invention, in the display apparatus of field sequential driving, the pixel voltages VP may simultaneously be charged in the liquid crystal capacitors 250 included in the pixel portions 200 and the liquid crystal capacitors 250 may be reset to insert the black image before the pixel voltages VP are charged in the liquid crystal capacitors 250. The display quality of the display apparatus 100 may be improved.

FIG. 8A and FIG. 8B are cross sectional views illustrating a display panel and a light source part.

Referring to FIG. 8A and FIG. 8B, the display panel 300 may include a first substrate 400, a second substrate 500, and a liquid crystal layer 600. The display panel 300 may be included in the display apparatus 100, and the display panel 300 may be similar to the display panel 110 illustrated in FIG. 1 and FIG. 2. The same reference numerals will be used to refer to same or like parts as those described in the previous exemplary embodiments and any further repetitive explanation will be omitted.

The first substrate 400 may include a first base substrate 410, a thin film transistor 210 formed on the first base substrate 410 and including a gate electrode 211, a source electrode 212, and a drain electrode 213, a gate insulating layer 430 formed on the first base substrate 410 and covering the gate electrode 421 of the thin film transistor 210. The first substrate 400 may further include an organic insulating layer 440 covering the thin film transistor 210 to protect the thin film transistor 210, and a pixel electrode 450 formed on the organic insulating layer 440 and electrically connected to the drain electrode 213 of the thin film transistor 210 through a contact hole formed through the organic insulating layer 440. The first substrate 400 may be a lower substrate.

The second substrate 500 may include a second base substrate 510, a color filter layer including a first color filter 531 having a first color, a second color filter 532 having a second color, and a transparent filter 533, a light blocking layer 520 formed between the first color filter 531 and the second color filter 532 and between the second color filter 532 and the transparent filter 533, an overcoat layer 530 formed on the color filter layer and the light blocking layer 520, and a common electrode 540 formed on the overcoat layer 530. The first color filter 531 may be a red color filer, and the second color filter 532 may be a green color filter. The second substrate 500 may be an upper substrate.

The liquid crystal layer 600 may include a liquid crystal of which an alignment is changed by an electric field formed between the pixel electrode 450 of first substrate 400 and the common electrode 540 of second substrate 500.

The display panel 300 may include a first sub pixel area SP1 in which the first color filter 531 is disposed, a second sub pixel area SP2 in which the second color filter 532 is disposed, and a third sub pixel area SP3 in which the transparent filter 533 is disposed.

The light source part 700 may include a first light source 711, a second light source 712, and a light guide plate 720. The second light source 712 may be a third color light source generating a third color different from the first color and the second color, for example, the second light source 712 may be a blue light emitting diode emitting a blue light. The first light source 711 may be a fourth color light source generating a fourth color different from the first color, the second color, and the third color, for example, the first light source 711 may be a yellow light emitting diode emitting a yellow light. The light guide plate 720 may guide light emitted from the first light source 711 or may guide light emitted from the second light source 712 to the display panel 300.

FIG. 9 is a timing diagram illustrating a time period of an image data applied to the display panel 300 of FIG. 8.

Referring to FIG. 8A, FIG. 8B, and FIG. 9, the frame period FRAME may include a first sub frame period SF1 and a second sub frame period SF2. Each of the first sub frame SF1 and the second sub frame SF2 may include a first time T1, a second time T2, a third time T3, and a fourth time T4.

FIG. 8A illustrates a driving of the display panel 300 performed in the first sub frame period SF1, and FIG. 8B illustrates a driving of the display panel 300 performed in the second sub frame period SF2.

The data voltages VD corresponding to data signals DS may sequentially be charged in the memory capacitors 240 included in the pixel portions 200 in response to the gate signals GS being sequentially applied to the gate lines GL during the first time T1 of the first sub frame period SF1.

The data voltages VD charged in the memory capacitors 240 may be boosted in response to the boosting voltage VBST being applied to the boosting voltage line VBSTL from the voltage supplying part 170 during the second time T2 of the first sub frame period SF1. The previous pixel voltages previously charged in the liquid crystal capacitors 250 may be reset in response to the reset signal RS being applied to the reset signal line RL from the control signal generating part 160 during the second time T2 of the first sub frame period SF1.

The data voltages VD charged in the memory capacitors 240 may simultaneously be transferred to the liquid crystal capacitors 250 to charge the pixel voltage VP to the liquid crystal capacitors 250 in response to the update signal US being applied to the update signal line UL from the control signal generating part 160 during the third time T3 of the first sub frame period SF1.

The first light source 711 may be turned on and the second light source 712 may be turned off during the fourth time T4 of the first sub frame period SF1. Yellow light may be outputted from the light source part 700 to the display panel 300, thus the display panel 300 may display a red image in the first sub pixel area SP1, display a green image in the second sub pixel area SP2, and display a yellow image in the third sub pixel area SP3.

The data voltages VD corresponding to data signals DS may sequentially be charged in the memory capacitors 240 included in the pixel portions 200 in response to the gate signals GS being sequentially applied to the gate lines GL during the first time T1 of the second sub frame period SF2.

The data voltages VD charged in the memory capacitors 240 may be boosted in response to the boosting voltage VBST being applied to the boosting voltage line VBSTL from the voltage supplying part 170 during the second time T2 of the second sub frame period SF2. The previous pixel voltages previously charged in the liquid crystal capacitors 250 may be reset in response to the reset signal RS being applied to the reset signal line RL from the control signal generating part 160 during the second time T2 of the second sub frame period SF2.

The data voltages VD charged in the memory capacitors 240 may be simultaneously transferred to the liquid crystal capacitors 250 to simultaneously charge the pixel voltage VP to the liquid crystal capacitors 250 in response to the update signal US being applied to the update signal line UL from the control signal generating part 160 during the third time T3 of the second sub frame period SF2. During the second sub frame period SF2, the pixel voltages VP may not be charged in the liquid crystal capacitors 250 disposed in the first sub pixel area SP1 and the second sub pixel area SP2. The pixel voltages VP may be charged in the liquid crystal capacitors 250 disposed in the third sub pixel area SP3.

The first light source 711 may be turned off and the second light source 712 may be turned on during the fourth time T4 of the second sub frame period SF2. The blue light may be outputted from the light source part 700 to the display panel 300, and the display panel 300 may display a blue image in the third sub pixel area SP3.

An image having the first color and the second color may be displayed during the first sub frame period SF1, an image having the third color may be displayed during the second sub frame period SF2, and a display apparatus of dichromatic field sequential (DFS) may be implemented.

The display apparatus of DFS may include two light emitting parts, and the display apparatus of DFS may decrease power consumption compared to a display apparatus of field sequential driving. The display apparatus of DFS may include two sub frame periods, and thus lower high speed driving may be required to the display apparatus of DFS compared to the display apparatus of field sequential driving including three sub frame periods.

In the display apparatus of DFS, the pixel voltages VP may simultaneously be charged in the liquid crystal capacitors 250 included in the pixel portions 200 and the liquid crystal capacitors 250 may be reset to insert the black image before the pixel voltages VP are charged in the liquid crystal capacitors 250. The color mixture owing to a response start time difference of a liquid crystal, and thus a display quality of the display apparatus 100 may be improved.

According to the display panel, the method of driving the display panel, and the display apparatus having the display panel, a data voltage charged in a memory capacitor may be boosted, the boosted data voltage may be transferred to a liquid crystal capacitor to charge a pixel voltage to the liquid crystal capacitor, and thus a decrease of driving voltage driving a liquid crystal may be prevented.

The pixel voltages may simultaneously be charged in the liquid crystal capacitors included in pixel portions, and a black image may be inserted by resetting the liquid crystal capacitors before charging the pixel voltages to the liquid crystal capacitors, therefore, a color mixture due to a response start time difference of a liquid crystal and a display quality of the display apparatus may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display panel, comprising:
a plurality of gate lines transferring gate signals;
a plurality of data lines intersecting the gate lines and transferring data signals; and
a plurality of pixel portions defined by the gate lines and the data lines and comprising pixel electrodes and configured to charge a pixel voltage by using a first gamma signal and a second gamma signal, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased.

2. The display panel of claim 1, wherein the pixel voltage is simultaneously charged in the pixel portions.

3. The display panel of claim 1, wherein each of the plurality of pixel portions comprises:
a first thin film transistor connected to a gate line and a data line;
a memory capacitor connected to a drain electrode of the first thin film transistor to charge a data voltage corresponding to the data signal; and
a boosting voltage line connected to the memory capacitor and to transfer a boosting voltage to boost the data voltage charged in the memory capacitor.

4. The display panel of claim 3, wherein each of the plurality of pixel portions further comprises a second thin film transistor comprising a source electrode connected to the drain electrode of the first thin film transistor and the memory capacitor, a gate electrode connected to an update line, and a drain electrode connected to a liquid crystal capacitor.

5. The display panel of claim 4, wherein each of the plurality of pixel portions further comprises a third thin film transistor comprising a gate electrode connected to a reset line, and a drain electrode connected to the liquid crystal capacitor.

6. The display panel of claim 5, wherein each of the plurality of pixel portions further comprises a common voltage line connected to a source electrode of the third thin film transistor and configured to transfer a common voltage.

7. The display panel of claim 6, wherein the each of the plurality of pixel portions is configured to display a black image in response to a reset signal from the reset line.

8. A method of driving a display panel, the method comprising:
charging a data voltage in a memory capacitor by using a first gamma signal and a second gamma signal, the data voltage corresponding to a data signal applied from a data line, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased;
boosting the data voltage stored in the memory capacitor;
resetting a previous pixel voltage charged in a liquid crystal capacitor; and
transferring the data voltage charged in the memory capacitor to the liquid crystal capacitor to charge a pixel voltage in the liquid crystal capacitor.

9. The method of claim 8, wherein the pixel voltage is simultaneously charged in the liquid crystal capacitor.

10. The method of claim 8, wherein boosting the data voltage comprises applying a boosting voltage to boost the data voltage to the memory capacitor.

11. The method of claim 8, wherein resetting the previous pixel voltage comprises applying a reset signal to reset the previous pixel voltage to a gate electrode of a thin film transistor comprising a drain electrode connected to the liquid crystal capacitor.

12. The method of claim 11, wherein a source electrode of the thin film transistor is connected to a common voltage line transferring a common voltage, and resetting the previous pixel voltage comprises displaying a black image.

13. A display apparatus, comprising:
a display panel comprising a plurality of gate lines transferring gate signals, a plurality of data lines intersecting with the gate lines and transferring data signals, and a plurality of pixel portions defined by the gate lines and the data lines, each of the pixel portions comprising a pixel electrode and being configured to charge a pixel voltage by using a first gamma signal and a second gamma signal, the first gamma signal being changed from a first level lower than a common voltage to a second level higher than the common voltage as a grayscale is increased, the second gamma signal being changed from a third level higher than the common voltage to a fourth level lower than the common voltage as the grayscale is increased;
a gate driving part configured to output the gate signals; and
a data driving part configured to output the data signals.

14. The display apparatus of claim 13, wherein the pixel voltage is simultaneously charged in the pixel portions.

15. The display apparatus of claim 13, wherein each of the plurality of pixel portions comprises:
a first thin film transistor connected to the gate line and the data line;
a memory capacitor connected to a drain electrode of the first thin film transistor; and
a boosting voltage line connected to the memory capacitor and configured to transfer a boosting voltage.

16. The display apparatus of claim 15, wherein each of the plurality of pixel portions further comprises:
a second thin film transistor comprising a source electrode connected to the drain electrode of the first thin film transistor and the memory capacitor, a gate electrode connected to an update line, and a drain electrode connected to a liquid crystal capacitor; and
a third thin film transistor comprising a gate electrode connected to a reset line configured to transfer a reset signal in response to pixel voltage being reset in the liquid crystal capacitor, and a drain electrode connected to the liquid crystal capacitor.

17. The display apparatus claim 16, wherein each of the plurality of pixel portions further comprises a common voltage line connected to a source electrode of the third thin film transistor and configured to transfer a common voltage.

18. The display apparatus of claim 17, further comprising:
a power supplying part configured to supply the boosting voltage and the common voltage; and
a control signal generating part configured to output the reset signal and the update signal.

19. The display apparatus of claim 13, wherein the data driving part comprises:
a first gamma signal generating part configured to generate the first gamma signal; and
a second gamma signal generating part configured to generate the second gamma signal.

20. The display apparatus of claim 13, wherein the display panel comprises:
a first substrate comprising a first base substrate on which the gate line and the data line are disposed, a thin film transistor connected to the pixel electrode, and a pixel electrode; and
a second substrate comprising a second base substrate facing the first base substrate, and a color filter layer including a first color filter having a first color, a second color filter having a second color and a transparent filter, and
wherein the display apparatus further comprises a first light source generating a fourth color different from the first color and the second color, and a second light source generating a third color different from the first color, the second color and the fourth color, and
the first light source is turned on in a first sub frame period and is turned off in a second sub frame period, and the second light source is turned off in the first sub frame period and is turned on in the second sub frame period.
